(19) United States
(12) Patent Application Publication
(10) Pub. No.: US 2004/0127204 A1
(43) Pub. Date: Jul. 1, 2004

(54) Method and apparatus to establish communication

(76) Inventor: Brian V. Belmont, Portland, OR (US)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/330,539

(22) Filed: Dec. 30, 2002

(51) Int. Cl. H04M 3/00

(52) U.S. Cl. 455/418; 455/419

(57) ABSTRACT

Briefly, a method to establish a connection to a local area network by configuring a mobile unit (MU) of a wireless network with wireless local area network (WLAN) parameters. The configuration may be performed by using a telecommunication system messaging service to exchange the configuration information between the mobile unit and a public access point (AP) of the WLAN.

### BACKGROUND OF THE INVENTION

Modern wireless communication systems such as, wireless local area network (WLAN) communication systems, may include at least one mobile unit (MU) and at least one access point (AP). Furthermore, a WLAN communication system may include at least one public access point, also known to the one skilled in the art as a hotspot. The pubic access point may include at least one AP.

In order to establish a network connection between a MU and the public AP, a manual configuration of the MU may be performed with parameters of the public access unit. Those parameters may be stored in a memory stack of the MU. This memory stack may be referred as a wireless network stack. At a particular hotspot a user of the WLAN network may be required to configure, manually, particular network profiles. The manual configuration may be performed by entering various parameters in fields of the wireless network stack at the MU, for example, an extended service set identifier (ESSID), a wired equivalent privacy (WEP) key, a channel, and the like. The manual entry of these parameters may be burdensome and frustrating to the end-user and may result in entry errors. Furthermore, other methods of MU configuration may be required, for example, a credit card configuration method and/or other billing methods that may be required by different operators of the hotspots.

Thus, there is a need for—better ways to mitigate the above-described disadvantages of MU configuration.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a portion of a hybrid communication network according to an exemplary embodiment of the present invention;

FIG. 2 is a schematic illustration of a portion of a WLAN communication system according to an exemplary embodiment of the present invention; and

FIG. 3 is a flowchart of a method according to exemplary embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like. For example, “plurality of mobile unites” describes two or more mobile units.

It should be understood that the present invention may be used in a variety of applications. Although the present invention is not limited in this respect, the circuits and techniques disclosed herein may be used in many apparatuses such as units of a wireless communication system, such as for example, a WLAN may include communication units to transact data between a MU and an AP. Units of WLAN communication systems intended to be included within the scope of the present invention include, by way of example only, MU's, AP's, public AP's and the like.

Types of WLAN intended to be within the scope of the present invention include, although are not limited to, WLAN's in accordance with “IEEE-Std 802.11, 1999 Edition (ISO/IEC 8802-11: 1999)” standard, and more particularly WLAN's in accordance with “IEEE-Std 802.11b-1999 Supplement to 802.11-1999, Wireless LAN MAC and PHY specifications: Higher speed Physical Layer (PHY) extension in the 2.4 GHz band” standard, “IEEE-Std 802.11a-1999, Higher speed Physical Layer (PHY) extension in the 5 GHz band” standard and the like.

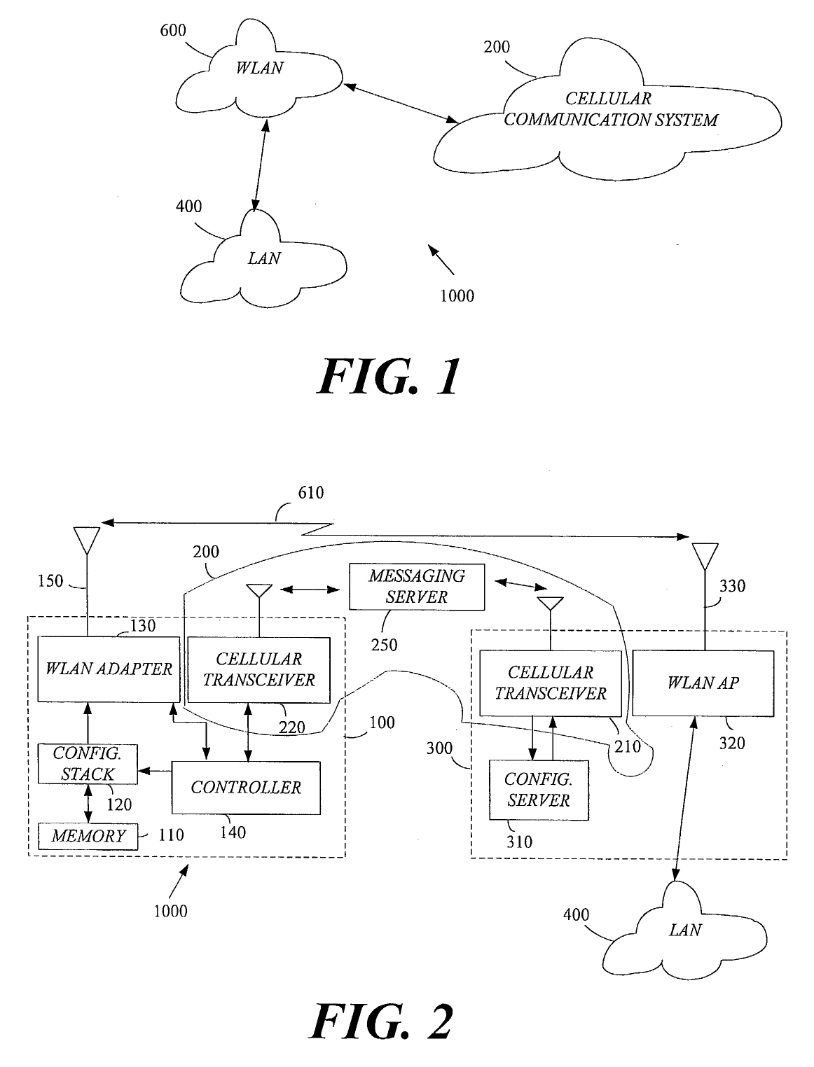

Turning first to FIG. 1, a portion of a hybrid communication network 1000 in accordance with the invention is shown. Although the scope of the present invention is not limited to this example, hybrid communication network 1000 may include a WLAN network 600, a LAN 400 and a wireless telecommunication system, such as, for example a cellular communication system 200. Although the scope of the present invention is not limited in this respect, cellular communication system 200 may be used to establish a connection between WLAN 600 units and between a WLAN user to LAN 400, if desired. However, in other embodiments of the present invention, other wireless telecommunication system such as, for example, a satellite phone system, a wireless phone system and the like.

Turning now to FIG. 2, a detailed schematic block diagram of a portion of hybrid communication network 1000 in accordance with the invention is shown. Although the scope of the present invention is not limited to this example, WLAN 600 may include a portion of a public AP 300 and a portion of a MU 100. In this embodiment of the present invention, the WLAN portion of public AP 300 may include a WLAN AP 320 a configuration server 310 and an antenna 330. Furthermore, the WLAN portion of MU 100 may include a memory 110, a configuration stack 120, a WLAN adaptor 130, and an antenna 140. In addition, cellular communication network 200 may include a messaging service 250, a cellular transceiver 220 that may be operably connected to MU 100 and a cellular transceiver 210 that may be operably connected to public AP 300, if desired.

It should be understood to one skilled in the art that, in alternative embodiments of the present invention, cellular transceivers 220 and 210 may not be included in MU 100 and/or in pubic AP 300, respectively. For example, cellular transceivers 220 and 210, MU 100 and public AP 300 may have infrared communication devices. Thus, cellular transceivers 220, 210, MU 100 and public AP 300 may be connected by the infrared communication devices, although the scope of the present invention is not limited in this respect.

In operation, a user of MU 100 may wish to establish-communication with public AP 300. In one embodiment of the present invention, the user of MU 100 may use cellular transceiver 220 to send a message to cellular transceiver 210. In one embodiment of the present invention, cellular transceivers 210, 220 may be transceivers of a. Global system for Mobile communication (GSM) cellular network and the user of MU 100 may send a Short Message Service (SMS) message through messaging service 250. Alternatively or additionally, in embodiments of the present invention, cellular transceivers 210, 220 may include transceivers of “third generation” cellular systems, such as, for example, Wideband Code Division Multiple Access (WCDMA) cellular transceivers, CDMA 2000 transceivers and the like. In those embodiments, if desired, the messaging service may include a Multimedia message service (MMS) and cellular transceiver 220 may send a MMS message to transceiver 210.

Although the scope of the present invention is not limited in this respect, a single message may be needed to initiate a process of establishing a connection between MU 100 and LAN 400. Cellular transceiver 220 may send a “Connect Me” message to cellular transceiver 210. Cellular transceiver 210 may provide the “Connect Me” message to configuration server 310. In response, configuration server 310 may send a message to MU 100 requesting hardware compatibility information, e.g., compatibility with standard 802.11a, 802.11b or the like as are known the one skilled in the art. However, in alternative embodiments of the invention, “Connect Me” message may include hardware compatibility information. For example, the hardware compatibility information of WLAN adapter 130 of MU 100 may include hardware (HW) information in accordance with standards 802.11a or 802.11b or the like.

Although the scope of the present invention is not limited in this respect, configuration of configuration stack 120 may be an automatic process. The configuration process may include automatically exchanging of SMS/MMS messages between MU 100 and public AP 300. This process may be referred to as a Machine to Machine (M2M) process, if desired.

Although the scope of the present invention is not limited in this respect, the compatibility information may be stored in memory 110. Controller 140 may read the compatibility information from memory 110 and/or from a register (not shown) and may generate a M2M message containing MU 100 capabilities. Furthermore, controller 140 may provide the message to cellular transceiver 220 to be sent by messaging service 250 to cellular transceiver 210 at public AP 300.

Although, the scope of the present invention is not limited in this respect, configuration server 310 at public AP 300 may receive the compatibility information and in return may generate a configuration information profile descriptor packet. For example, the configuration information profile descriptor packet may include, but is in no way limited to, the flowing data:

A name of the network, for example, the name of a coffee shop, hotel, airport and the like;

A contact number, for example, the SMS/MMS destination number for reconfiguration requests or for sending “failed to connect” messages;

geographical coordinates of network coverage;

LAN configuration information such as, for example, ESSID, Operation Mode, Channel, WEP Key, and the like; and

billing information.

Although the scope of the present invention is not limited in this respect, the cellular transceiver 220 may receive a message comprising the configuration information profile descriptor from messaging service 250. Controller 140 may receive the configuration information profile descriptor from cellular transceiver 220 and may store the configuration information profile descriptor at memory 110. In addition, controller 140 may configure configuration stack 120 with the configuration information profile descriptor and may activate WLAN adapter 130. WLAN adapter 130 may establish WLAN connection with WLAN AP 320 at public AP 300.

Although the scope of the present invention is not limited in this respect, antennas 150 and 330, for example dipole antennas and the like, may be used to establish a wireless connection through an air link 610.

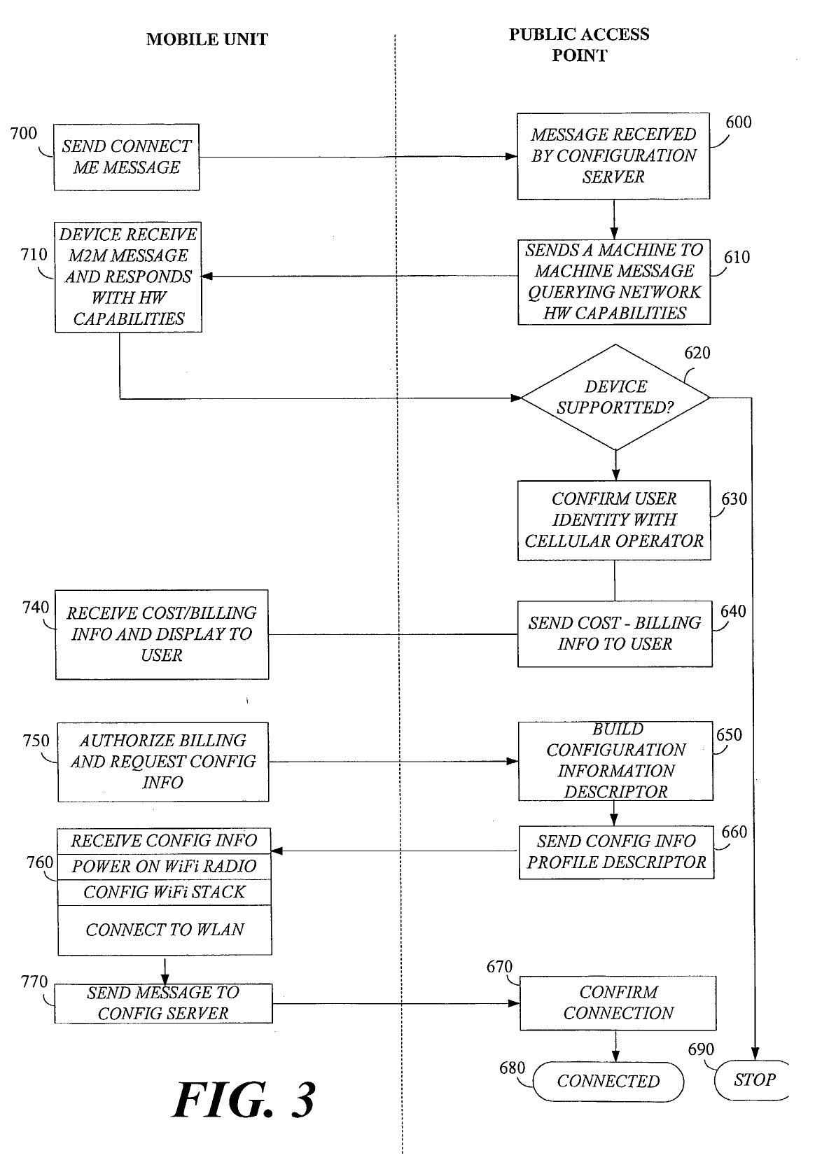

Turning to FIG. 3, a flowchart of a method for establishing a WLAN network connection according to an embodiment of the present invention is shown. The flowchart is divided by a doted line to distinguish between operations done at the mobile unit, for example MU 100 to operations done at the public access point, for example public AP 300, although the scope of the present invention is in no way limited in this respect.

Although the scope of the present invention is not limited in this respect, a user of WLAN, for example, a laptop computer equipped with MU 100 may be in an airport where public AP 300 is located and wishes to connect to LAN 400. A display at the location of public AP 300 may show the public AP's name, for example “JFK Airport” and a SMS/MMS message address to connect for configuration of the user MU, for example, a cellular telephone (“cellphone”) number.

Although the scope of the present invention is not limited in this respect, the method may start with a user of MU 100 sending a SMS/MMS “connect me” message to the cellphone whose number is shown on the display at public AP 300 (block 700). The message may be received by public AP 300 configuration server 310. In response, configuration server 310 may begin to exchange configuration information with MU 100 by sending SMS/MMS messages. For example the exchanging messages may be a M2M exchanging message process, if desired.

Although the scope of the present invention is not limited in this respect, in response to the “connect me” message, configuration server 310 may send to the user of cellphone transceiver 220 a querying network hardware (HW) capabilities message (block 610). MU 100 may receive SMS/MMS messages querying HW capabilities and may send SMS/MMS message with MU 100 HW capabilities (block 710). Public AP 300 may receive the HW capabilities of MU 100, e.g. 802.11b, and may test if the HW of MU 100 is supported by the HW of public AP 300 (block 620).

If the HW of MU 100 HW is not supported, the method may be stopped (block 690). If the HW of MU is supported, in one embodiment of the present invention, configuration server 310 may send SMS/MMS message or may use a secured LAN connection to the cellular operator to confirm user identity (block 630). In response, the cellular operator may send a “confirmed/not confirmed” message to public access point 300.

Although the scope of the present invention is not limited in this respect, if the cellular operator confirms the user identity, the operator may proceed to establish a WLAN network connection. Public AP 300 may send SMS/MMS messages or may use a secured LAN connection to the cellular operator to provide the costs, billing information and terms of a required WLAN service. In response, MU 100 may or may not authorize the billing terms. The user of MU 100 may authorized the billing terms by sending a SMS/MMS message or by using a secured LAN connection to the cellular operator to provide a configuration information request (block 750).

Although the scope of the present invention is not limited in this respect, in an embodiment of the present invention, configuration server 310 of public AP 300 may build a configuration information profile descriptor (block 650) and may send the configuration information profile descriptor by SMS/MMS message to MU 100 (block 660). In alternative embodiments of the present invention, the body SMS/MMS message may be encrypted. The encryption may be performed using any encryption method known to the one skilled in the art, such a public key/private key encryption, if desired.

Although the scope of the present invention is not limited in this respect, MU 100 may receive the configuration information profile descriptor and may store the configuration information profile descriptor in a list of public AP's. In addition, MU 100 may activate a WLAN radio, for example, WLAN adapter 130 and the like. Furthermore, MU 100 may configure WLAN configuration stack, for example, configuration stack 120 and may establish a WLAN connection to LAN 400 (block 760). MU 100 may send a connection message to configuration server 310 over an air link 610 of the WLAN (block 770). Public AP 300 may confirm the connection message (block 570) and may establish connection to the LAN 400 (block 680).

Although the scope of the present invention is not limited, in other embodiment of the present invention, establishing a connection between MU 100 and public AP 300 may be performed by searching the public AP list in memory 110. If a configuration information profile descriptor is found, a new connection may be established by configuring configuration stack 120 with the configuration information profile descriptor from the public AP list. If a configuration information profile descriptor is not found, the WLAN connection may be established using the above-described method.

While certain features of the invention have been illustrated and described herein, many modifications, substitutions, changes, and equivalents will now occur to those skilled in the art. It is, therefore, to be understood that the appended claims are intended to cover all such modifications, substitutions, changes and equivalents as may fall within the true spirit of the invention.

What is claimed is:

1. A method comprising:
configuring a mobile unit to establish a wireless network connection between the mobile unit and a wireless local area network by using a messaging service to exchange configuration information between the mobile unit and a public access point of the wireless local area network.

2. The method of claim 1, comprising:
sending a message from the mobile unit to the public access point using the messaging service; and
receiving from the public access point a configuration information profile descriptor.

3. The method of claim 2, further comprising:
configuring the mobile unit according to the configuration information profile descriptor; and
establishing said wireless network connection between the mobile unit and the public access point.

4. The method of claim 3, further comprising:
accepting billing terms before configuring the mobile unit.

5. The method of claim 3, further comprising:
storing the configuration information profile descriptor in a list of configuration information profile descriptors of public access points.

6. The method of claim 5, further comprising:
Selecting from the list a configuration information profile descriptor;
establishing the wireless connection to the public access point by configuring the mobile unit according to the selected configuration information profile descriptor.

7. A method comprising:
using a messaging service to send from a public access point of a wireless local area network to a mobile unit configuration information to configure a wireless network configuration stack of the mobile unit.

8. The method of claim 7, further comprising:
receiving a message of the messaging service from the mobile unit; and
sending a configuration information profile descriptor to the mobile unit on the messaging service.

9. The method of claim 8, further comprising:
sending billing terms to the mobile station;
receiving from the mobile station an acceptance messages for the billing terms; and
sending the configuration information profile descriptor after receiving a confirmation to the billing terms.

10. An apparatus comprising:
a transceiver able to send and receive messages using a wireless telecommunication network messaging service;
a wireless network configuration stack; and
a controller able to receive a configuration information profile descriptor provided via the messaging service, wherein the configuration information profile descriptor is used to configure the wireless network configuration stack.

11. The apparatus of claim 10, further comprising:
a memory to store the configuration information profile descriptor and data relating to the billing information of a user.

12. The apparatus of claim 10, further comprising a wireless local area adapter to establish a local area network connection via a public access point based on the configuration information profile descriptor.

13. The apparatus of claim 11, wherein the transceiver comprises a global system for mobile communication (GSM) transceiver.

14. The apparatus of claim 12, wherein the wireless local area adapter complies with wireless local standard IEEE 802.11a.

15. The apparatus of claim 12, wherein the wireless local area adapter complies with wireless local standard IEEE 802.11b.

16. An apparatus comprising:
a global system for mobile communication (GSM) transceiver able to send and receive messages using a GSM messaging service;
a wireless network configuration stack; and
a controller able to receive a configuration information profile descriptor provided via the GSM messaging service, wherein the configuration information profile descriptor is used to configure the wireless network configuration stack.

17. The apparatus of claim 16, further comprising:
a memory to store the configuration information profile descriptor and data relating to the billing information of a user.

18. The apparatus of claim 16, further comprising a wireless local area adapter to establish a local area network connection via a public access point based on the configuration information profile descriptor.

19. Ali article comprising: a storage medium having stored thereon instructions that when executed result in:
configuring a mobile unit to establish a wireless network connection between the mobile unit and a wireless local area network by using a messaging service to exchange configuration information between the mobile unit and a public access point of the wireless local area network.

20. The article of claim 19, wherein the instructions when executed result in:
sending a message from the MU to the public access point using the messaging service; and
receiving from the public access point a configuration information profile descriptor.

21. The article of claim 20, wherein the instructions when executed result in:
configuring the mobile unit according to the configuration information profile descriptor; and
establishing said wireless network connection between the mobile unit and the public access point.

22. The article of claim 21 wherein the instructions when executed result in:
accepting billing terms before configuring the mobile unit.

23. The article of claim 21 wherein the instructions when executed result in:
storing the configuration information profile descriptor in a list of configuration information profile descriptors of public access points.

24. The article of claim 23 wherein the instructions when executed result in:
selecting from the list a configuration information profile descriptor;
establishing the wireless connection to the public access point by configuring the mobile unit according to the selected configuration information profile descriptor.
